(19) United States
(12) Patent Application Publication
(10) Pub. No.: US 2007/0162537 A1
(43) Pub. Date: Jul. 12, 2007

(54) Common application services framework

(75) Inventor: Robert M. Juncker, Farmington, MN (US)

Correspondence Address: FAEGRE & BENSON LLP;PATENT DOCKETING, 2200 WELLS FARGO CENTER, 90 SOUTH SEVENTH STREET, MINNEAPOLIS, MN, 55402-3901, US

(73) Assignee: Gearworks, Inc., Eagan, MN (US)

(21) Appl. No.: 11/652,287

(22) Filed: Jan. 11, 2007

Related U.S. Application Data
(60) Provisional application No. 60/758,278, filed on Jan. 11, 2006.

(51) Int. Cl. G06F 15/16

(52) U.S. Cl. 709/200

(57) ABSTRACT

A system for providing applications for mobile service providers includes a common application services framework providing one or more interfaces to communicate with applications accessible by one or more mobile communication devices, and providing a web-based interface to the one or more mobile communication devices using a plurality of communication formats and/or via a plurality of telecommunication carrier networks.

### CROSS-REFERENCE TO RELATED APPLICATIONS

This application claims the benefit of Provisional Application No. 60/758,278, filed on Jan. 11, 2006, which is hereby incorporated by reference for all purposes.

### COPYRIGHT NOTICE

Contained herein is material that is subject to copyright protection. The copyright owner has no objection to the facsimile reproduction of the patent disclosure by any person as it appears in the Patent and Trademark Office patent files or records, but otherwise reserves all rights to the copyright whatsoever. Copyright© 2006 Gearworks, Inc.

### TECHNICAL FIELD

Various embodiments of the present invention generally relate to systems and methods for application development and deployment. More specifically, embodiments of the present invention relate to common application services frameworks.

### BACKGROUND

In many service industries, service personnel (field workers) are dispatched to a remote location to perform a specified service. For example, plumbers may be dispatched to a home to fix a plumbing problem. To provide the best service possible, while keeping costs down and profits up, companies that dispatch their service personnel attempt to do so as efficiently and effectively as possible. At a minimum, efficient and effective deployment of service personnel require that the central dispatching office know where service personnel are at all times, as well as which service personnel is best situated to handle a call, and an accurate route to the call. As such, typical systems require constant communication contact, and can require sophisticated computing systems.

Traditional systems have not provided simple, yet integrated and scaleable means for managing the dispatching operations, particularly on an enterprise-wide basis. Often, a company may have an existing dispatching system that has been developed or modified to fit the company's specific business practices. Such business-specific dispatch systems are often inflexible. These traditional systems often cannot be integrated with other parts of the business, such as sales, billing, or time sheets for service personnel in the field. In addition, these custom systems typically are not scaleable to handle changes in technology. For example, if a business data application at the home office is updated to a newer version or a different vendor, this may require an entirely new set of equipment or processes for workers or vehicles in the field. As a result, such inflexible systems can result in great cost, both in terms of worker time lost to training, and equipment and software development expense.

Another issue relates to adoption of applications that must operate in conjunction with dispatching applications. Often, a telecommunication carrier, such as Sprint® or Verizon®, will provide applications to mobile service providers. Such applications may be billing applications or workflow applications, for example. Traditionally, applications that are developed on the carrier's network must be integrated with each mobile service provider's mobile application and the carrier's back-end systems. The process of application development and integration with mobile and back-end systems typically involves the carrier and a mobile service provider entering into a contract that sets forth the terms of use and functionality. Terms of use and functionality of applications tend to be specific to the particular mobile service provider. As such, applications are not easily shared with, and are often not adopted by, a broader range of mobile service providers. Consequently, traditional approaches toward mobile application development and deployment cannot take advantage of economies of scale that might be achievable.

### SUMMARY

Systems and methods are described for application development and deployment. More specifically, embodiments of the present invention relate to common application services frameworks. In some embodiments, a system for providing applications to mobile service providers includes a mobile application platform (MAP). The MAP can host one or more network-based applications developed by an application provider. The one or more network-based applications may be accessible by at least one of a plurality of mobile service providers and at least one of a plurality of service provider home offices. In some embodiments, the MAP hosts a plurality of industry generic service modules each configured for use by the one or more network-based applications developed by the application provider.

The one or more network-based applications, according to various embodiments, developed by the application provider may be wrappers combining one or more of the industry generic service modules with one or more industry specific service modules. In at least one embodiment, the network-based applications run on the MAP and a mobile communication device interfaces the network-based applications through an input/output layer of the MAP.

One or more communication devices may be each associated with one of the plurality of mobile service providers in accordance with one or more embodiments. Some of the communication devices may be capable of executing an embedded browser allowing one of the plurality of mobile service providers to access an application executing on the a server associated with MAP.

Some embodiments of the present invention include a method of operating a mobile applications platform (MAP). According to some embodiments, the MAP may receive mobile work force data statistics associated with each of a plurality of mobile workers in a work force. In one embodiment, the mobile work force data statistics can include capability indicia related to mobile communication devices used by the plurality of mobile workers.

The MAP may also enable one or more application service providers access to the mobile work force data statistics in accordance with some embodiments. In at least one embodiment, the MAP may receive one or more network-based applications developed by at least one of the one or more application providers based on the mobile work force data statistics, wherein the one or more network-based applications make use of at least one service module hosted on the MAP. In various embodiments, the MAP may also allow communication devices associated with members of a mobile work force access to the one or more network-based applications received.

In accordance with one or more embodiments of the present invention a system for providing applications to mobile service providers may include a MAP. The MAP may be accessible to one or more application providers, one or more service provider home offices, and one or more mobile service providers. In some embodiments, the MAP includes an interface for the one or more application providers to submit application programs, wherein some of the application programs are common across multiple industries and other application programs are industry-specific.

While multiple embodiments are disclosed, still other embodiments of the present invention will become apparent to those skilled in the art from the following detailed description, which shows and describes illustrative embodiments of the invention. As will be realized, the invention is capable of modifications in various aspects, all without departing from the scope of the present invention. Accordingly, the drawings and detailed description are to be regarded as illustrative in nature and not restrictive.

### BRIEF DESCRIPTION OF THE DRAWINGS

FIG. 1 illustrates an exemplary operating environment including exemplary mobile devices communicating via a network(s) with a mobile application platform.

FIG. 2 is a diagrammatic representation of a mobile application platform in accordance with one embodiment of the present invention.

FIGS. 3-6 are screen shots of web pages that may be generated by a mobile application platform and presented on a monitor/screen of a computing device.

FIG. 7 is a flow chart illustrating an algorithm having exemplary operations for monitoring a mobile workforce and presenting web-based content associated with the mobile workforce.

FIG. 8 is a schematic diagram of a computing device upon which a software-based mobile application platform may be implemented and/or a mobile communication device may be implemented.

While the invention is amenable to various modifications and alternative forms, specific embodiments have been shown by way of example in the drawings and are described in detail below. The intention, however, is not to limit the invention to the particular embodiments described.

### DETAILED DESCRIPTION

Definitions

Prior to describing one or more preferred embodiments of the present invention, definitions of some terms used throughout the description are presented.

A “mobile application platform” refers generally to a common application services framework upon which applications can be developed, and/or including applications for use by mobile users. Generally, a mobile application platform provides interfaces through which applications can access portions of the platform or vice versa. A mobile application platform may be implemented in software on a general-purpose computing device, a special-purpose computing device, or other suitable computing device. Embodiments of a mobile application platform can provide for mobile device integration and mobile application integration. As described further herein, some embodiments of mobile application platforms are web-based, on-demand application platforms.

The term “carrier” refers broadly to any type of telecommunications carrier. A carrier typically maintains a network, such as a wireless or cellular network, over which mobile service providers, and others can communicate and/or make use of applications associated with a mobile application platform. Carriers can also provide services (e.g., applications) on their network. By way of example, but not limitation, Nextel®, Verizon®, and Sprint® are telecom carriers.

The term “partner” refers to an entity that develops and/or provides applications or devices associated with or in communication with, a mobile application platform. Partners may be part of a syndicate of partners that leverage the functionality of a common mobile application platform. Such applications are typically useable by mobile users, such as mobile service providers, through a wireless mobile communication device. By way of example, but not limitation, Motorola® may be a partner by virtue of Motorola's VIAMOTO™ suite of location-based services. As another example, Nextel may be a partner by virtue of Nextel's GPS and Java-enabled handsets which provide access to mobile application platform applications.

The term “customer” includes mobile service provider companies who dispatch mobile service providers to field locations to provide services. Such mobile service providers typically have a wireless mobile communication device, through which they may communicate with applications associated with a mobile application platform. By way of example, but not limitation, lawn maintenance companies, food and drink distributors, product delivery companies, and companies that use field technicians, may be customers by virtue of services that they provide “in the field”.

The phrases “in one embodiment,” “according to one embodiment,” and the like generally mean the particular feature, structure, or characteristic following the phrase is included in at least one embodiment of the present invention, and may be included in more than one embodiment of the present invention. Importantly, such phases do not necessarily refer to the same embodiment.

If the specification states a component or feature “may”, “can”, “could”, or “might” be included or have a characteristic, that particular component or feature is not required to be included or have the characteristic.

The term “module” refers broadly to a software, hardware, or firmware (or any combination thereof) component. Modules are typically functional components that can generate useful data or other output using specified input(s). A module may or may not be self-contained. An application program (also called an “application”) may include one or more modules, or a module can include one or more application programs.

The term “responsive” includes completely or partially responsive.

The term “computer-readable media” is media that is accessible by a computer, and can include, without limitation, computer storage media and communications media. Computer storage media generally refers to any type of computer-readable memory, such as, but not limited to, volatile, non-volatile, removable, or non-removable memory. Communication media refers to a modulated signal carrying computer-readable data, such as, without limitation, program modules, instructions, or data structures.

Embodiments of the present invention may be provided as a computer program product which may include a machine-readable medium having stored thereon instructions which may be used to program a computer (or other electronic devices) to perform a process. The machine-readable medium may include, but is not limited to, floppy diskettes, optical disks, compact disc read-only memories (CD-ROMs), and magneto-optical disks, ROMs, random access memories (RAMs), erasable programmable read-only memories (EPROMs), electrically erasable programmable read-only memories (EEPROMs), magnetic or optical cards, flash memory, or other type of media/machine-readable medium suitable for storing electronic instructions. Moreover, embodiments of the present invention may also be downloaded as a computer program product, wherein the program may be transferred from a remote computer to a requesting computer by way of data signals embodied in a carrier wave or other propagation medium via a communication link (e.g., a modem or network connection).

For the sake of illustration, various embodiments of the present invention have herein been described in the context of computer programs, physical components, and logical interactions within modern computer networks. Importantly, while these embodiments describe various aspects of the invention in relation to modem computer networks and programs, the method and apparatus described herein are equally applicable to other systems, devices, and networks as one skilled in the art will appreciate. As such, the illustrated applications of the embodiments of the present invention are not meant to be limiting, but instead exemplary. Other systems, devices, and networks to which embodiments of the present invention are applicable include, but are not limited to, other types communication and computer devices and systems. More specifically, embodiments are applicable to communication systems, services, and devices such as cell phone networks and compatible devices. In addition, embodiments are applicable to all levels of computing from the personal computer to large network mainframes and servers.

Exemplary System

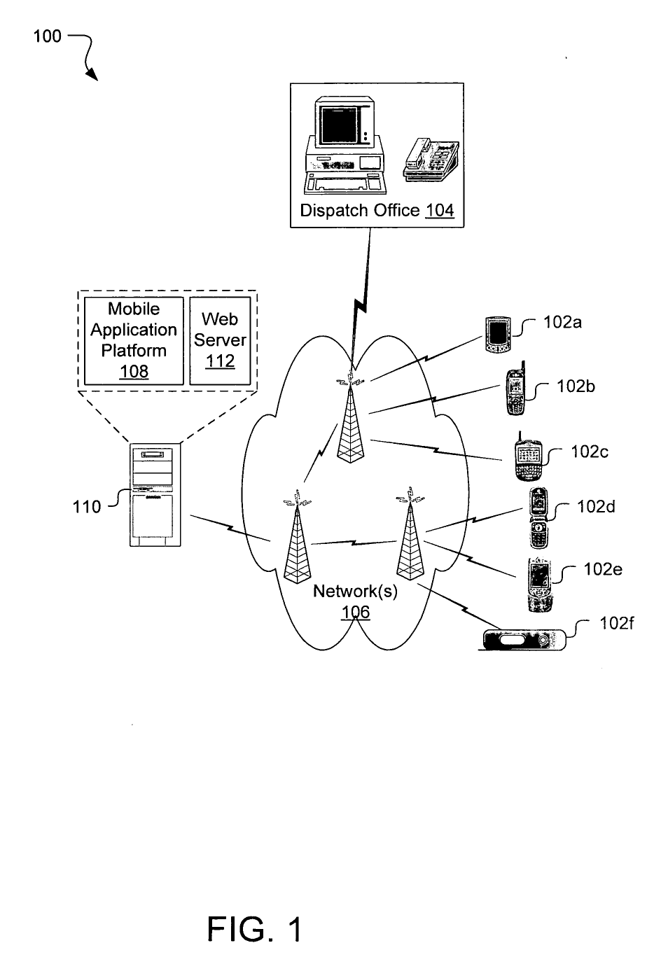

FIG. 1 illustrates an exemplary common mobile operating environment 100 including one or more exemplary mobile communication devices 102 and one or more static communication devices, such as computing devices in home dispatch offices 104, communicating via a network 106. The mobile devices 102 and the home dispatch offices 104 are in communication with a mobile application platform 108 via the network 106. The mobile application platform (MAP) 108 generally provides one or more application services and/or data that are useable by applications running on the mobile devices 102 and/or computing devices at the dispatch office 104. The mobile application platform 108 is a common platform upon which applications can be developed and deployed for a mobile workforce. In addition, MAP 108 can be used to aggregate multiple applications developed by various different carriers, partners, or others, such that users can access the applications at a single common logical location (e.g., a Uniform Resource Locator (URL) or an IP address on the network 106).

In one embodiment, the mobile application platform 108 runs on one or more server computers 110 which execute a web server 112. The web server 112 provides an interface to web-based applications (e.g., browsers) executing on the mobile devices 102. Although the web server 112 is shown in FIG. 1 as being separate from the MAP 108, in other embodiments, the web server 112 may be included in the MAP 108. The server computer 110 may be in communication with one or more databases (not shown) that store data related to mobile applications, customers, partners, and others. Partners, carriers, and others that develop third party applications useable in the common mobile operating environment 100 deploy the applications to the server computer(s) 110, where they interface with the mobile application platform 108. Mobile communication devices and computing devices associated with the dispatch office 104 can be clients of the MAP 108.

Users of communications devices 102 and home/office 104 computers can be any type of users in any setting. As such, users may be generally categorized as either mobile or static. Although the users can be of any type, for illustrative purposes, in the described embodiments mobile communication devices 102 are assumed to be used by a mobile workforce. Mobile communication devices 102 are typically relatively small so that they are easily carried by mobile workers, such as plumbers, electricians, field technicians, delivery personnel, home medical providers, and others. Mobile communication devices 102 are typically GPS-enabled, provide wireless communication, and include input/output means, such as audio, a screen, touch screen input, keypad, and others. Mobile communication devices 102 may also include push-to-talk (PTT) functionality. PTT is a two-way communication service that works like a “walkie-talkie”. PTT is half-duplex, meaning that communication can only travel in one direction at any given moment. As such, a mobile communication device 102 is typically operable to input and output a variety of data, such as, but not limited to, voice, graphics, numerical, and application-specific data. Some mobile communication devices 102 may be capable of inputting and/or outputting other data such as audio, images, and video.

By way of example, but not limitation, mobile communication devices 102 include personal digital assistants (PDA) 102a, JAVA-based phones 102b (e.g., Blackberry®), cellular telephones, such as “black-phones” 102c, BREW-based phones 102d, and Windows-based phones 102e, as well as vehicle-mounted “black boxes” 102f. A black box 102f is a device that is installed in a vehicle with no interface, but has embedded intelligence which allows it to capture vehicle diagnostic information and GPS positioning information.

In some embodiments, one or more of the mobile communication devices 102 each execute an embedded browser (e.g., a web or Internet browser), which may be intelligent and/or device-specific. Through the browser, a mobile worker can access applications executing on the computer server 110 in conjunction with the mobile application platform 108. The communication devices 102 each may have telecommunication carrier-specific branding, such as Sprint®, Nextel®, Cingulair®, or others. Through their interaction with the mobile application platform 108, the mobile communication devices 102 integrate with location based services, such as user plane services. In some embodiments, applications executing on the mobile communication devices 102 provide dynamic, extensible markup language (XML)-based screen formatting, content, fields, or others. Mobile applications may also provide for dynamic screen content transformation.

Through the mobile communication devices 102, the mobile application platform 108 advantageously enables rapid mobilization of applications across carriers, provides device transparency for applications, and provides unified access to peripherals (scanner, camera, printer, etc.). The mobile application platform 108 may use push or pull methods of communicating data and application interaction, or a combination thereof. The web server 112 can communicate via hypertext markup language (HTML) over a transmission control protocol/Internet protocol (TCP/IP) protocol. The web server 112 can implement a common gateway interface (CGI), or other Internet interface, through which mobile communication devices 102 can access applications associated with the mobile application platform 108.

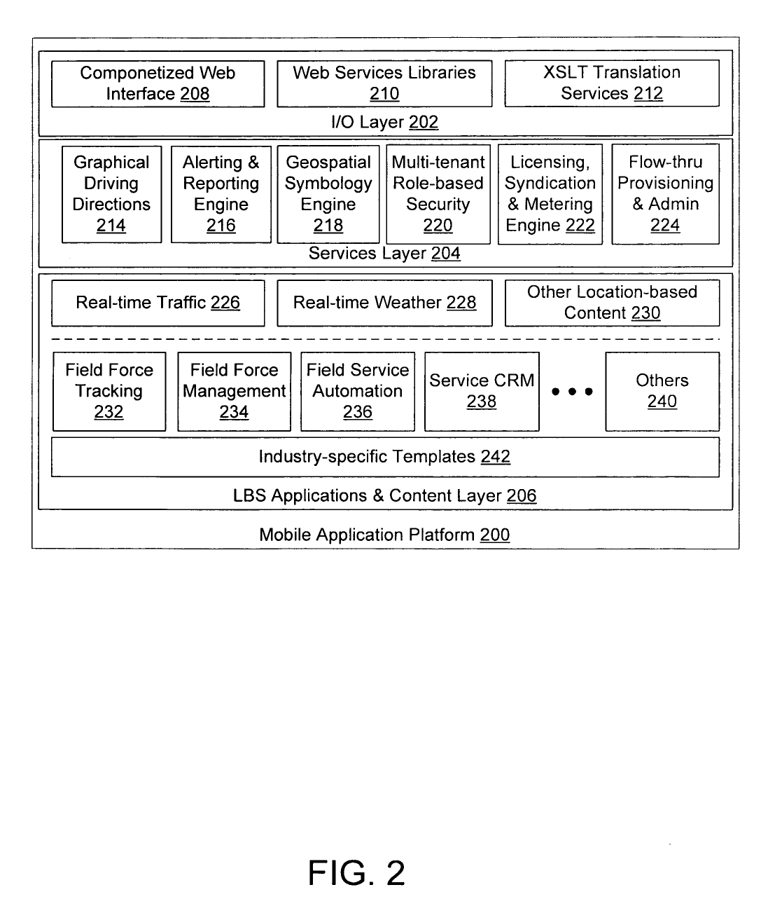

MAP 108 also provides applications to the dispatch office 104, which can include computing and communication devices for carrying out the coordination of the mobile services workforce. MAP 108, in conjunction with the web server 112, provide a common web-based application to the dispatch office 104. Underlying applications provide further content that can be used or provided by the web-based application. As such, exemplary application programs associated with the MAP 108 provide mapping and/or field worker tracking functionality, for example by using GPS data from mobile devices 102. Other applications can be provided on the common MAP 108 that can provide comprehensive mobile services functionality well-suited for mobile services industries. By way of example, MAP 108 may include timecard applications, billing, messaging/alerting, job scheduling, sales, metrics gathering, higher-level business applications, and/or others. Exemplary applications are discussed in more detail below with regard to FIG. 2.

Although the network 106 is illustrated as a single network, the network 106 may include or be composed of one or more subnetworks. One or more of the subnetworks may be associated with, or deployed/maintained by, a carrier. The mobile application platform 108 may provide some applications that are carrier-specific and other applications that are not carrier-specific. As such, the applications provided by the mobile application platform 108 do not need to be limited to any particular carrier. Beneficially, carriers can sell access to mobile data and mobile applications associated with the mobile applications platform 108. Mobile data and mobile applications associated with the MAP 108 may be generically available through multiple carriers. Subnetworks within the network 106 may include wired or wireless, or any combination thereof. For example, the dispatch office 104 may communicate with/through the network 106 via a wireline connection (e.g., through a private or public switch).

FIG. 2 is a diagrammatic representation of a mobile application platform (MAP) 200 in accordance with one embodiment of the present invention. In this particular embodiment, applications associated with MAP 200 are on-demand. Using applications of the MAP 200, partners and carriers are provided a write-once run-any methodology, thereby leveraging the scope of these applications. Because mobile browsers employ dynamic XML-based screens and content, the on-demand applications can be syndicated and delivered as content to an end user application (e.g., an application program executing on a mobile communication device). In the embodiment shown in FIG. 2, MAP 200 includes an input/output (I/O) layer 202, a services layer 204, and a location based services (LBS) applications and content layer 206.

The I/O layer 202 provides a web-based interface through which accessing communication devices can communicate with other layers of the MAP 200. Accordingly, the I/O layer 202 includes a componentized web interface (CWI) 208, one or more web services libraries 210, and extensible style language transformation (XSLT) translation services 212. Generally, the CWI 208 includes one or more modules that enable a client web browser to request data from an application program associated with the MAP 200, such as an application executing at one of the other layers of the MAP 200. As such, the CWI 208 specifies a standard for passing request data to and from an application program used to service that request. Web service libraries 210 is a collection of data used by the CWI 208. XSLT is a language used by XML style sheets to transfer one form of an XML document to another XML form. This transition can be very useful in e-commerce and e-business, because it serves as a common denominator across many different platforms and varying XML document coding.

The services layer 204 generally can provide for any types of services that can make use of mobile workforce related data, such as content generated by the LBS applications and content layer 206. Application programs at the services layer 204 can be developed by partners and carriers (e.g., in a syndicate), or others. Thus, for example, in the illustrated embodiment services layer 204 includes a graphical driving directions module 214, an alerting and reporting engine 216, a geospatial symbology engine 218, a multi-tenant role-based security module 220, a licensing, syndication, and metering engine 222, and a flow-thru provisioning and administration module 224.

In various embodiments, the graphical driving directions module 214 employs maps of areas, such as city/street maps, in order to generate driving directions using GPS data from mobile communications devices. The alerting and reporting engine 216 can generate real-time alerts to a home dispatch office or mobile communication device. The alerts can be prioritized. Geospatial symbology engine 218 can generate symbols, for use on maps, based on geographic and spatial data, and can determine proper scale associated with maps.

Syndicated on-demand applications at the services level 204 can include, but are not limited to mobile payroll services and/or sales force automation. Application programming interfaces can be provided by syndicated partners or providers. Examples of syndicated APIs are transportation, mobile healthcare, enterprise resource planning (ERP), CRM, and supply chain management (SCM) APIs.

Referring to the multi-tenant role-based security module 220, role-based security allows a company to define specific roles in their company and the specific rules that govern what information that role has access to. For example, an “accountant” might have access to only completed jobs that need to be billed and privileges to access the associated mobile worker's salary information for job-costing analysis. By contrast, a “dispatcher” role would typically not have access to user salary information. A dispatcher may be granted privileges to access information regarding jobs that need to be worked or are currently assigned.

According to at least one embodiment, the multi-tenant role-based security module 220 enhances role-based security by enabling business partners to setup exterior facing rules. Exterior facing rules can be customized, configured, and/or adapted for customers. For example, if a national towing service has contracted local towing services in various geographic locations, the national towing service dispatchers will typically have access to all of the dispatch-related information. At the same time, a local contracting towing service that subscribes to MAP 200 services would have the ability to access information for the national towing service that pertains to the geographical area which the local contractor serves.

In one embodiment, the licensing syndication and metering engine 222 monitors and/or manages usage of one or more modules in the MAP 200. For example, through the licensing syndication and metering engine 222, a partner that provides a MAP 200 module that generates turn-by-turn driving directions can monitor and/or manage usage of this module to determine how often each customer is using the module. This usage information can be used for billing purposes. For example, if a customer buys 300 uses of the module, the metering engine, 222 can determine if the customer has reached the 300 use limit. If the customer exceeds the use limit, other billing processes may be triggered, such as an overage charge, or others.

One challenge for partners, or application providers, who develop components for use by mobile service providers relates to the deployment or provisioning of the component. Because each mobile service provider may employ different mobile workers who use different mobile devices in different roles, conventional approaches have not allowed for a relatively simple, “one-time” deployment. Often in the past, the component would need to be rolled out to each mobile service provider individually. Embodiments of the flow-thru provisioning and administration module 224 greatly simplify the component deployment process. Among other functions, the flow-thru provisioning and administration module 224 feeds provisioning information to the partners. Such provisioning information may include mobile worker information (e.g., number of workers, identifiers, jobs, etc.), mobile device information, and security and role information, just to name a few. Using this information, the partner can develop a component (e.g., an application) that can handle all customers. In addition, the partner can instantly and automatically deploy the component to the MAP 200 in a single deployment.

The LBS applications and content layer 206 generally includes applications for generating and/or monitoring real-time field worker data. Thus, for example, the LBS applications and content layer 206 includes a real-time traffic module 226 to monitor traffic real-time, a real-time weather module 228 to monitor weather real-time, and other location-based content module(s) 230 for monitoring/generating other relevant location-based parameters.

The LBS applications and content layer 206 also includes a number of modules for real-time monitoring or management of a mobile workforce. These modules include a field force tracking module 232, a field force management module 234, a field service automation module 236, a service CRM module 238, and other module(s) 240. Other modules 240 may include, for example, a timecard application that records or monitors worker time spent on service jobs and generates reports of worker time spent at jobs. LBS modules typically make use of real-time location information (e.g., GPS data). Industry-specific templates 242 can provide data specific to particular industries, for use in MAP application programs. For example, templates may be included that define how worker time is computed for purposes of timecards, compensation, or billing.

Other applications that may be provided by embodiments of MAP 200 include, but are not limited to: mobile document capture, black box integration, non-Java phone tracking, real-time fleet maps, stop reports, geo-fencing, real-time configurable alerting, data field configuration, location directory, job dispatch, configurable job types (job attributes, actions, job and worker symbology rules), job scheduling & workflow tracking, real-time job and worker symbology on fleet maps, print forms/service receipt, interactive voice response (IVR), point-of-sale processing with credit card capture, printed payment transaction receipt.

One embodiment of a data field configuration application is a data capture mechanism that allows administrative users to determine the flow of data capture and fields being captured. Through the data field configuration application, an administrator can specify the fields and flow of data capture in such a way as to correspond to mobile field workers' workflow. After the fields and data flow are specified, the data field configuration application sends them out to the mobile devices. In this way, changes are centralized as opposed to being embedded in application logic.

An embodiment of an IVR application provides enhanced IVR services. For example, the IVR application can perform automatic user authentication and intention determination. A patent application entitled “IVR Authentication and Intention Verification System”, with patent application Ser. No. ______, filed on even date herewith, and commonly owned, discloses an enhanced IVR system for use with MAP 200. This patent application is hereby incorporated by reference for all purposes. Briefly, the IVR application provides for automatic authentication of a field worker, and can automatically determine the field worker's intention on a job. The IVR application may employ PTT technology. Alternatively, the IVR application may be accessed through a full-duplex communication session. An IVR application may allow for advanced data collection, validation, workflow and external database data lookup.

Geo-fencing refers to geo-awareness in a particular area. Using latitude and longitude points or a single point with a radius of a specified distance, a geo-fencing application in the MAP 200, can use GPS information from a mobile device to automatically determine if a user (e.g., mobile field worker) has entered or departed a specific geographic zone. The geo-fencing application can issue alerts based on specified condition(s), such as entry or departure from the geographic zone.

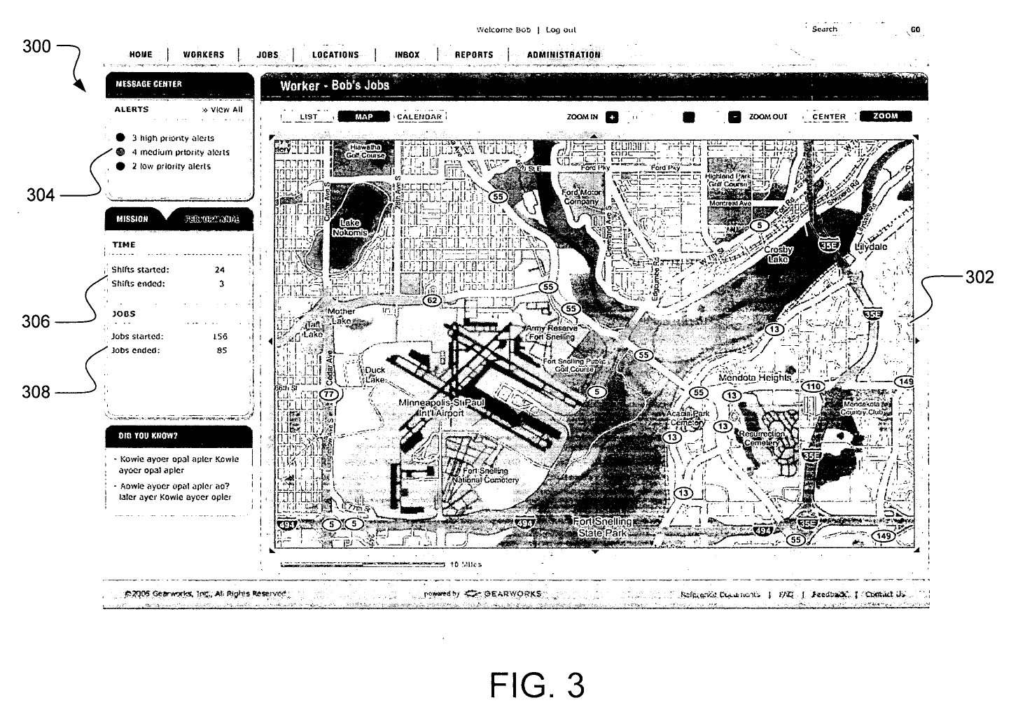

FIG. 3 is a screen shot of a web browser window 300 including an exemplary map 302 that may be generated by an application of the mobile application platform. For example, the graphical driving directions module 214 (FIG. 2) and/or the geospatial symbology engine 218 (FIG. 2) might generate the map 300 for presentation on a computer display screen. The window 300 also presents alerts 304 in a prioritized fashion, worker shift time data 306, and job tracking (e.g., count) data 308. Typically, the web browser window 300 is presented on a computer screen at a home/dispatch office, or mobile command center.

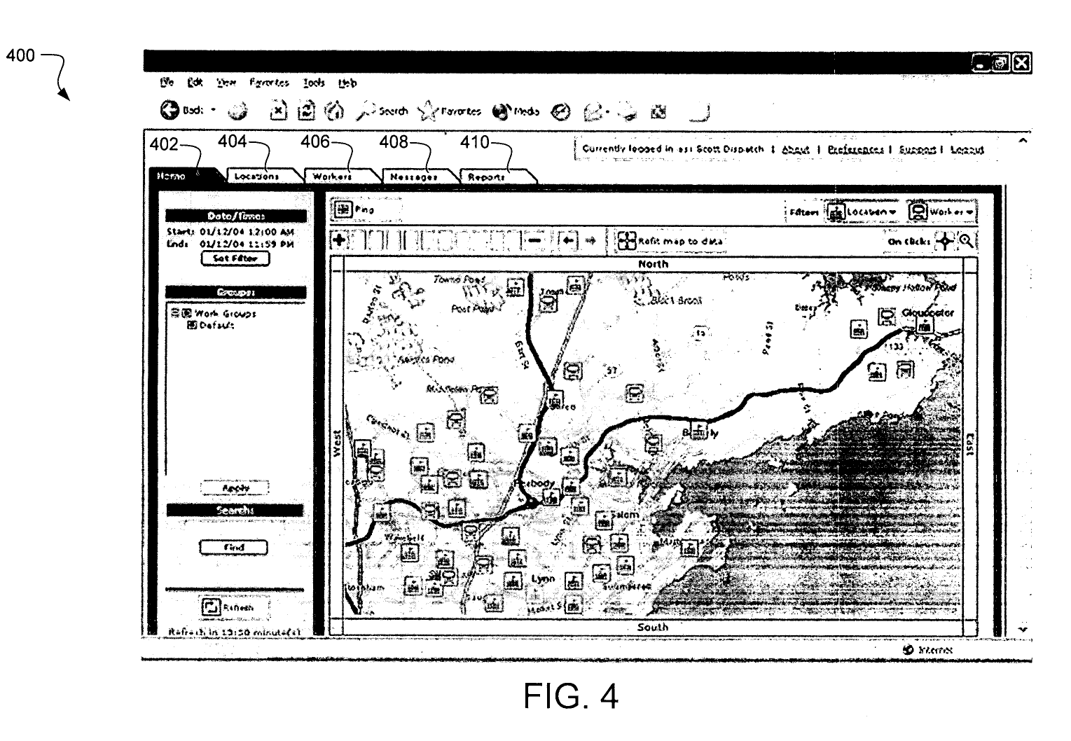

FIG. 4 is another screen shot of a web browser window 400 with a map displayed on a selected “Home” tab 402 in accordance with one embodiment of the present invention. In the embodiments of web pages shown herein, text and other data may be presented in a markup language, such as Hypertext Markup Language (HTML). Text and/or data presented in this fashion is selectable by the user and may cause an action to occur, such as browser navigation to another web page. The web pages may include various types of content, such as, but not limited to text, graphics, video, audio, or tables. In addition, the content may be dynamically updated.

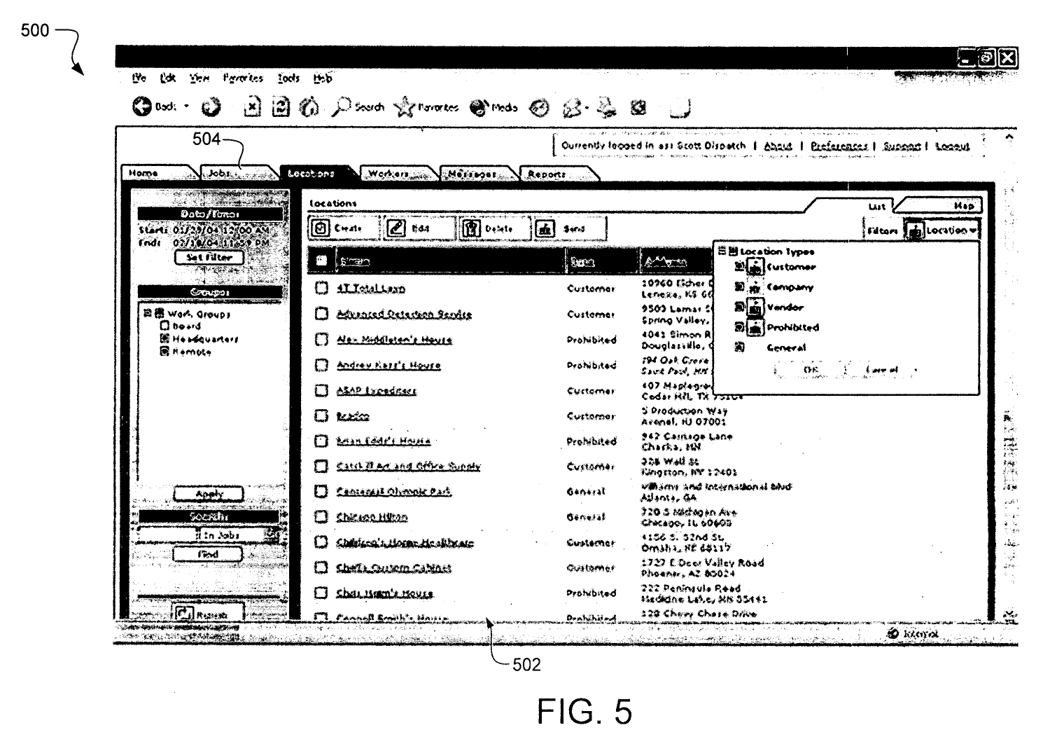

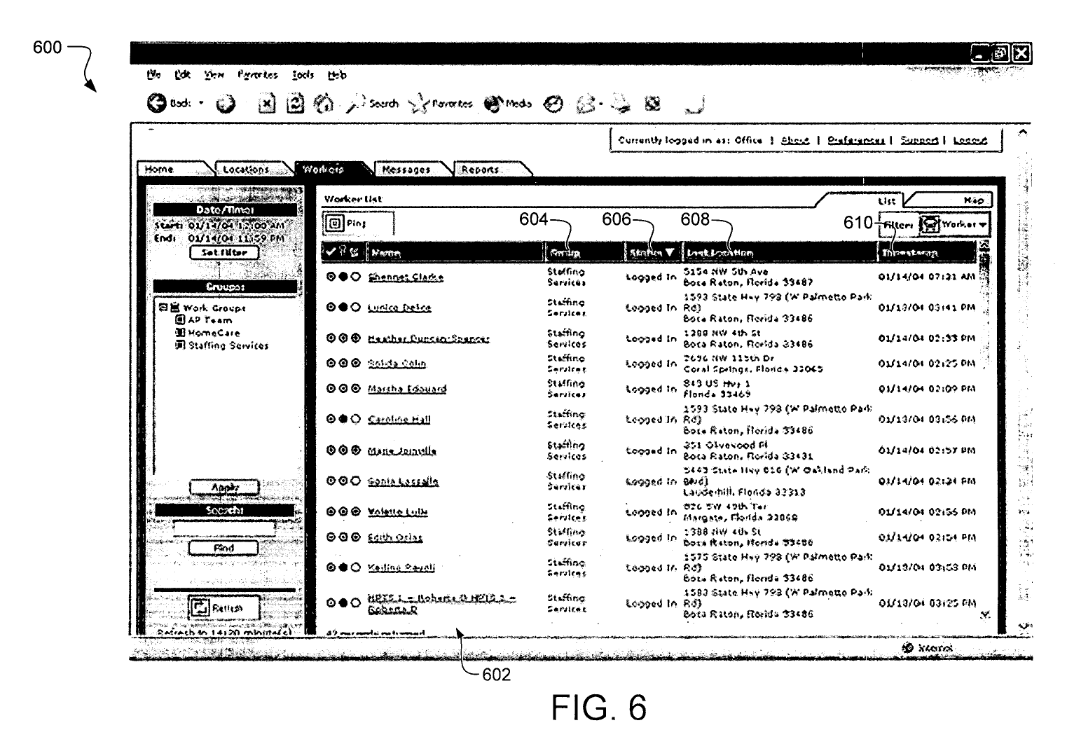

Other tabs presented on browser page 400 are “Locations” tab 404, “Workers” tab 406, “Messages” tab 408, and “Reports” tab 410. When selected, the Locations tab 404 presents a browsable list of locations associated with field workers or jobs. FIG. 5, discussed below, illustrates exemplary content that can be displayed on the Locations tab 406. When selected, the Workers tab 406 presents a browsable list of worker names. FIG. 6, discussed below, illustrates exemplary content of a Workers tab in accordance with one embodiment. The Messages tab 408 presents a browsable list of messages on the screen. Messages on the Messages tab 408 can be messages exchanged between field workers, between field workers and the dispatch office, and others. When selected, the Reports tab 410 presents reports and/or alerts associated with workers, jobs, or others. Data presented on any of the tabs may be dynamically updated based on communications from workers in the field and/or dispatch personnel.

FIG. 5 illustrates a screen shot of a browsable web page 500 presented in a window, wherein the browsable web page 500 includes a browsable list of locations 502. In this embodiment, the locations 502 are given in street address format; however, in other embodiments locations may be presented in other formats, such as, but not limited to, latitude/longitude. Also shown on the web page 500 is a selectable “Jobs” tab 504. When the user selects the “Jobs” tab 504, a web page is presented that includes a browsable list of jobs that may be associated with workers in the field.

FIG. 6 illustrates a screen shot of another browsable web page 600 including a browsable list of workers 602, along with data associated with each of the workers. In this embodiment, a group name 604, a status indicator 606, a last location 608, and timestamp 610 are shown for each worker. If the use selects one of the worker names, more information about the worker may be presented. Using the above exemplary web pages, a dispatcher at a home office can advantageously monitor and/or manage workers, jobs, locations, and others.

Exemplary Operations

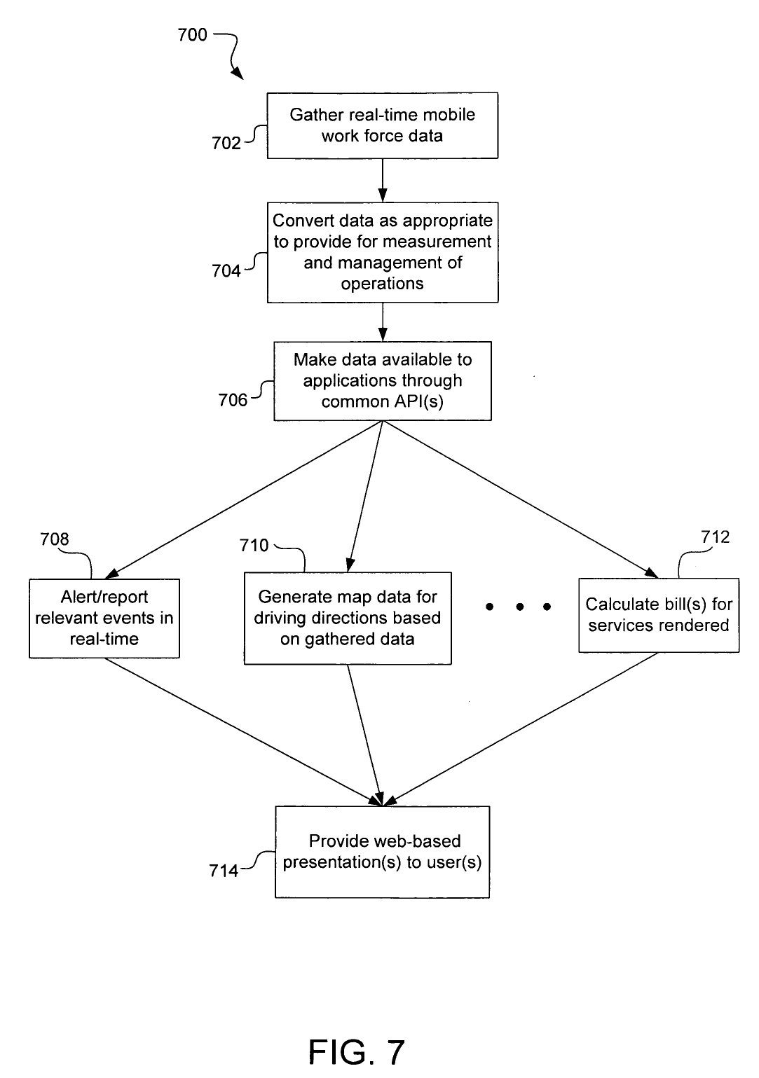

FIG. 7 is a flow chart illustrating an algorithm 700 having exemplary operations for gathering data associated with mobile workers on a real-time basis, and using the gathered data to provide web-based application data. The exemplary operations shown in FIG. 7 may be carried out by a mobile applications platform, such as the mobile applications platform 200 shown in FIG. 2. However, the operations of FIG. 7 are not limited to such a mobile applications framework.

A gathering operation 702 gathers data associated with a mobile workforce on a real-time basis. The data may be worker location (e.g., GPS position), current weather conditions, current traffic conditions, job schedules, and others. The gathering operation 702 may receive the data from sources such as mobile communication devices, dispatch computing devices, or weather/traffic services. The data is typically communicated via one or more carrier networks. The data may be gathered in a “push” and/or “pull” manner, or otherwise. For example, data may be periodically uploaded to a commonly accessible database by communication devices and retrieved later from the database.

A converting operation 704 converts the gathered data as appropriate so that the data is useable by application programs that provide various services, such as measurement and management functions. In one embodiment, the converting operation 704 converts the data into format(s) specified in application programming interfaces that application programs interface with. Converting data may also involve encoding and/or encrypting the data. A making available operation 706 makes the converted data available to the various application programs, for example via the APIs.

Next, multiple operations may or may not occur in parallel. By way of example, but not limitation, an alerting operation 708 may generate alert data that can be used by dispatchers when specified events occur that relate to the mobile workforce. As another example, a generating operation 710 can generate map data for use in creating a map with driving directions. As yet another example, a calculating operation 712 can use the gathered data to compute bills for services that have been provided by field workers. In one embodiment, the exemplary operations 708, 710, and 712 are carried out by application programs aggregated at a common logical location (e.g., network location).

Finally, a providing operation 714 provides web-based presentation(s) to users. The users may or may not be mobile. For example, the web-based presentations may be provided to a mobile field worker on a PDA; or, the presentations may be provided to a dispatcher at a home office on a desktop/laptop computer. In one embodiment, XML data is generated to present content to the users. The web-based presentations can typically be viewed by a web browser. The presentations may include various different types of data in various different formats, such as, but not limited to graphical (e.g., images, video), audio (e.g., voice), numerical, and application-specific. One or more of the operations illustrated in FIG. 7 may be carried out in a different order as shown, and may be reorganized and/or combined in any manner as may be appropriate for a particular implementation.

Exemplary Computing Device

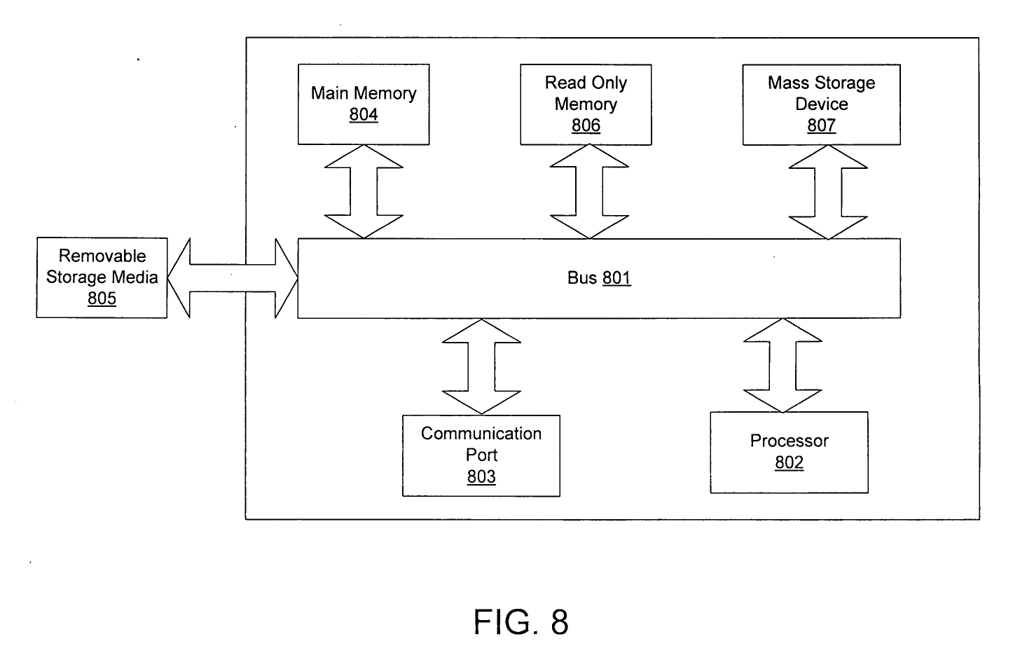

FIG. 8 is a schematic diagram of a computing device 800 upon which a software-based mobile application platform may be implemented and/or a mobile communication device may be implemented. As discussed herein, embodiments of the present invention include various steps. A variety of these steps may be performed by hardware components or may be embodied in machine-executable instructions, which may be used to cause a general-purpose or special-purpose processor programmed with the instructions to perform the steps. Alternatively, the steps may be performed by a combination of hardware, software, and/or firmware.

According to the present example, the computing device 800 includes a bus 801, at least one processor 802, at least one communication port 803, a main memory 804, a removable storage media 805 a read only memory 806, and a mass storage 807. Processor(s) 802 can be any know processor, such as, but not limited to, an Intel® Itanium® or Itanium 2® processor(s), or AMD® Opteron® or Athlon MP® processor(s), or Motorola® lines of processors. Communication port(s) 803 can be any of an RS-232 port for use with a modem based dialup connection, a 10/100 Ethernet port, or a Gigabit port using copper or fiber. Communication port(s) 803 may be chosen depending on a network such a Local Area Network (LAN), Wide Area Network (WAN), or any network to which the computing device 800 connects. The computing device 800 may be in communication with peripheral devices (not shown) such as, but not limited to, printers, speakers, cameras, microphones, or scanners.

Main memory 804 can be Random Access Memory (RAM), or any other dynamic storage device(s) commonly known in the art. Read only memory 806 can be any static storage device(s) such as Programmable Read Only Memory (PROM) chips for storing static information such as instructions for processor 802. Mass storage 807 can be used to store information and instructions. For example, hard disks such as the Adaptec® family of SCSI drives, an optical disc, an array of disks such as RAID, such as the Adaptec family of RAID drives, or any other mass storage devices may be used.

Bus 801 communicatively couples processor(s) 802 with the other memory, storage and communication blocks. Bus 801 can be a PCI /PCI-X or SCSI based system bus depending on the storage devices used. Removable storage media 805 can be any kind of external hard-drives, floppy drives, IOMEGA® D Zip Drives, Compact Disc-Read Only Memory (CD-ROM), Compact Disc-Re-Writable (CD-RW), Digital Video Disk-Read Only Memory (DVD-ROM).

Various modifications and additions can be made to the exemplary embodiments discussed without departing from the scope of the present invention. For example, while the embodiments described above refer to particular features, the scope of this invention also includes embodiments having different combinations of features and embodiments that do not include all of the described features. Accordingly, the scope of the present invention is intended to embrace all such alternatives, modifications, and variations together with all equivalents thereof.

What is claimed is:

1. A system for providing applications to computing devices configured to communicate over a network, the system comprising:
a network-based mobile application platform (MAP) hosting one or more applications developed by an application provider, wherein the one or more applications are accessible by a plurality of mobile computing devices and a static computing device associated with the mobile computing devices; and
wherein the MAP hosts a plurality of industry generic service modules, each industry generic service module configured to be used by the one or more applications developed by the application provider.

2. The system of claim 1, wherein the at least one of the one or more applications developed by the application provider comprises a wrapper combining one or more of the industry generic service modules with one or more industry specific service modules, wherein a mobile communication device interfaces with the one or more applications through an input/output layer of the MAP.

3. The system of claim 1, wherein at least one of the one or more mobile communication devices are capable of executing an embedded browser that accesses one of the one or more applications.

4. The system of claim 1, wherein at least one of the one or more communication devices includes a push-to-talk (PTT) functionality.

5. The system of claim 1, wherein the MAP provides unified access to one or more peripherals chosen from a group consisting of a scanner, a camera, and a printer.

6. The system of claim 1, wherein each mobile computing device is used by a mobile service provider and the static computing device is at a dispatch office associated with the mobile service providers.

7. The system of claim 6, wherein the one or more applications on the MAP include a field worker tracking application usable by the dispatch office to collect global positioning system (GPS) data collected from one or more mobile communication devices and present the collected GPS data to the dispatch office.

8. The system of claim 1, wherein the plurality of industry generic service modules hosted on the MAP are selected from a group consisting of a timecard application, a billing application, a messaging/alerting application, a job scheduling application, a sales application, a metric gathering application, and a higher-level business application.

9. A method of making applications available to mobile workers, the method comprising:
receiving mobile work force data associated with each of a plurality of mobile workers in a work force, wherein the mobile work force data includes capability indicia related to mobile communication devices used by the plurality of mobile workers;
enabling one or more application providers to access the mobile work force data and to develop one or more applications based at least in part on the mobile work force data;
receiving the one or more applications at a network-based mobile applications platform (MAP);
hosting the one or more applications on the MAP, wherein the one or more MAP-hosted applications make use of at least one service module also hosted on the MAP; and
enabling the mobile communication devices associated with the plurality of mobile workers to access the one or more MAP-hosted applications.

10. The method of claim 9, wherein the received mobile work force data includes data from one or more of a mobile communication device, dispatch computing device, a weather service, and a traffic service.

11. The method of claim 9, wherein the MAP includes one or more applications to determine local conditions of the plurality of mobile workers in the work force, wherein the local conditions include one or more of current weather conditions, current traffic conditions, and job schedules associated with one or more mobile workers in the mobile work force.

12. The method of claim 9, further comprising converting the received mobile work force data by encoding the data in a format that allows communication devices to use the mobile work force data statistics.

13. The method of claim 9, further comprising generating alert data to be used by a dispatch office, wherein the alert data is based on the received mobile work force data and data retrieved from one or more industry generic service modules.

14. The method of claim 9, wherein at least one of the one or more network-based applications incorporate a graphical driving directions module hosted on the MAP and provides driving directions to a member of the mobile work force by:
generating map data based on a current location of one of the plurality of mobile workers in the mobile work force; and
creating a map with driving directions to direct the one of the plurality of mobile workers in the mobile work force to a next destination based on current road conditions, current location of the member of the mobile work force, job schedule, and traffic patterns.

15. The method of claim 9, further comprising computing bills for services that have been provided by one or more of the plurality one of mobile workers in the mobile work force.

16. The method of claim 9, further comprising delivering a web-based presentation to at least one of the plurality of mobile workers in the mobile work force through a personal digital assistant (PDA).

17. A computer-readable medium having computer executable instructions, which when executed cause the computer to carry out the method of claim 9.

18. A system for providing applications to mobile service providers, the system comprising:
a mobile application platform (MAP) accessible to one or more application providers, one or more service provider home offices, and one or more mobile service providers, wherein the MAP includes an interface for the one or more application providers to submit application programs, wherein some of the application programs are common across multiple industries and other application programs are industry-specific.

19. The system of claim 18, wherein the MAP further comprises:
an input/output (I/O) layer providing a web-based interface through which communication devices can communicate with layers of the MAP;
a location based services (LBS) applications and content layer including applications to monitor and generate real-time field worker data from mobile work force data received from one or more mobile communication devices; and
a services layer including one or more applications that are able to use the mobile work force related data collected by the LBS applications and content layer to generate additional information about an environment of the one or more mobile communication devices.

20. The system of claim 19, wherein the MAP further comprises one or more network-based applications which are accessible by communication devices usable by members of a mobile work force and the one or more network-based applications include mobile payroll services or sales force automation.

21. The system of claim 19, wherein the I/O layer includes a componentized web interface (CWI) with one or more modules that enable a client web browser to request data from an application program associated with the MAP, one or more web services libraries containing a collection of data accessible by the CWI, and an extensible style language transformation translation services usable to translate a first extensible markup language (XML) document to second XML document.

22. The system of claim 19, wherein the services layer includes one or more of the following:
a graphical driving directions module to generate driving directions based on global positioning system (GPS) data received from one or more mobile communication devices;
an alerting and reporting engine to generate real-time alerts to a home dispatch office or mobile communication device;
a geospatial symbology engine to generate one or more symbols based on geographic and special data which can be used on a map accessible to a member of a mobile work force;
a multi-tenant role-based security module to govern access to information and subsystems within the MAP based on one or more rules stored accessible by the multi-tenant role-based security module;
a licensing, syndication, and metering engine to monitor and manage the use of one or more modules in the MAP, and
a flow-thru provisioning and administration module provides mobile worker information, mobile device information, and security and role information to a partner for use in development of a MAP component.
